(19) United States
(12) Patent Application Publication
(10) Pub. No.: US 2012/0084003 A1
(43) Pub. Date: Apr. 5, 2012

(54) ELECTRONIC DEVICE AND OPERATION METHOD OF THE SAME

(76) Inventors: Eunyoung Park, Seoul (KR); Seungbum Hong, Seoul (KR); Sungwoo Kim, Seoul (KR); Jongsoo Lee, Seoul (KR); Jiho Choi, Seoul (KR); Myungeun Park, Seoul (KR); Jiyoung Huh, Seoul (KR)

(21) Appl. No.: 13/056,940

(22) PCT Filed: Oct. 4, 2010
(86) PCT No.: PCT/KR2010/006759

§ 371 Date: Jan. 31, 2011

(51) Int. Cl. G01C 21/00

(52) U.S. Cl. 701/439

(57) ABSTRACT

The present invention relates to an electronic device and an operation method of the electronic device. The present invention provides an electronic device and an operation method of the electronic device that can provide a user with wanted information at a proper time and at a proper location by obtaining destination information including at least one of a target location and a target location arrival time, obtaining at least one of a current location and a current time, and determining an application to be executed considering the obtained destination information and the current location and current time, wherein as the current location and the current time change, the application varies.

### BACKGROUND

1. Technical Field

The present invention relates to an electronic device and an operation method of the electronic device, and more specifically to an electronic device and an operation method of the electronic device obtaining guidance information from a predetermined application considering relations between current location and current time, and destination location and destination arrival time and provides the obtained guidance information.

2. Discussion of the Related Art

Various methods for providing various types of information to users through electronic devices have been developed since the information revolution.

There is a need for research that provides more useful and user-oriented information to users.

### SUMMARY

An object of the present invention is to provide an electronic device and an operation method of the electronic device that can provide a user with necessary information at a proper time and at a proper location.

Another object of the present invention is to provide an electronic device and an operation method of the electronic device that can provide a user with different types of information according to the type of destination at a proper time and at a proper location.

An electronic device according to an aspect of the present invention comprises an output unit, and a controller configured to execute one or more applications, wherein the controller obtains at least one of a destination location and a destination location arrival time, determines an application to be executed considering at least one of a first relation between a current time and the destination location arrival time and a second relation between a current location and the destination location, obtains guidance information related to health from the determined application, and outputs the obtained health-related guidance information through the output unit, wherein as one of the first relation and the second relation changes, the determined application varies.

An operation method of an electronic device according to an aspect of the present invention comprises the steps of obtaining at least one of a destination location and a destination location arrival time, determining an application to be executed considering at least one of a first relation between a current time and the destination location arrival time and a second relation between a current location and the destination location, obtaining guidance information related to health from the determined application, and outputting the obtained health-related guidance information through an output unit, wherein as one of the first relation and the second relation changes, the determined application varies.

The electronic device and the operation method of the electronic device according to the present invention have the following effects:

According to the present invention, information necessary for a user may be actively obtained and the obtained information may be provided at a proper time and at a proper location.

According to the present invention, different types of information according to the type of destination may be provided at a proper time and at a proper location.

### BRIEF DESCRIPTION OF THE DRAWINGS

The embodiments of the present invention will become readily apparent by reference to the following detailed description when considered in conjunction with the accompanying drawings wherein:

FIG. 1 schematically illustrates an environment according to an embodiment of the present invention;

FIG. 2 illustrates a construction of the electronic device 100 according to an embodiment of the present invention;

FIG. 3 is a flowchart illustrating a method of providing various types of information according to an embodiment of the present invention;

FIG. 4 is a view illustrating a method of providing various types of information according to an embodiment of the present invention;

FIG. 5 is a view illustrating an exemplary application to be executed according to an embodiment of the present invention;

FIG. 6 illustrates an example of guidance information according to an embodiment of the present invention;

FIGS. 7 to 11 illustrate examples of guidance information according to an embodiment of the present invention;

FIG. 12 illustrates an example of guidance information according to a destination property according to an embodiment of the present invention;

FIG. 13 illustrates an example of guidance information in a case where the destination is a grocery store according to an embodiment of the present invention;

FIGS. 14 and 15 are views illustrating guidance information in a case where the destination is a grocery store according to an embodiment of the present invention;

FIG. 16 illustrates an example of guidance information in a case where the destination is a public institution according to an embodiment of the present invention;

FIG. 17 is a view illustrating guidance information in a case where the destination is a public institution according to an embodiment of the present invention;

FIG. 18 illustrates an example of guidance information in a case where the destination is an airport according to an embodiment of the present invention; and

FIG. 19 is a view illustrating guidance information in a case where the destination is a public institution according to an embodiment of the present invention.

### DESCRIPTION OF THE EMBODIMENTS

The foregoing objects, features, and advantages of the present invention will be apparent from the detailed description taken in conjunction with the accompanying drawings. Embodiments of the present invention will be described in detail with reference to the accompanying drawings. The same reference numerals refer to the same elements throughout the specification and the drawings. If it is determined that detailed description on the known constructions or functions related to the present invention may render the gist of the present invention unclear, the detailed description will be omitted.

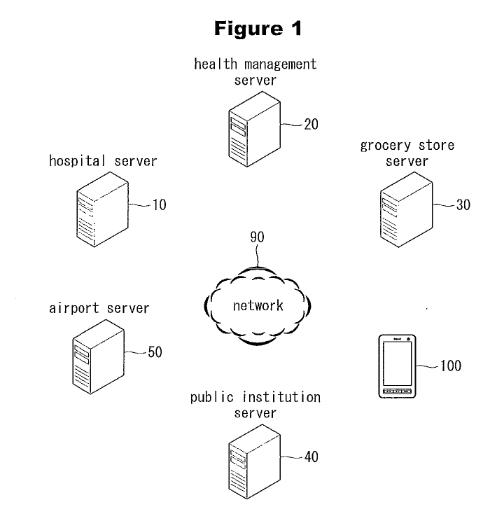

FIG. 1 schematically illustrates an environment according to an embodiment of the present invention.

The environment according to the embodiment may include a network environment that may provide a user with necessary information appropriate for a time and place.

The environment may include a hospital server 10, a health management server 20, a grocery store server 30, a public institution server 40, an airport server 50, a network 90, and an electronic device 100. These components are not necessary, and thus, more or less components may be included in the embodiment.

The hospital server 10 may provide patient's checkup records and integrally managing information related to hospital operation, for example, such as reservations or treatment times. Further, the hospital server 10 may provide or receive various types of information to/from the electronic device 100 through the network 90.

The health management server 20 may manage information related to patient's health conditions and may receive various types of information related to patient's health conditions from the hospital server 10. The health management server 20 may also provide various types of information to the electronic device 100 through the network 90.

The grocery store server 30 may manage various types of information associated with grocery stores and may provide the various types of information to the electronic device 100 through the network 90.

The public institution server 40 may manage various types of information associated with services provided by public institution and may provide the various types of information to the electronic device 100 through the network 90.

The airport server 50 may manage various types of information, for example, such as information related to takeoff or landing of airplanes or passengers. The airport server 50 may provide information managed by the airport server 50 to the electronic device 100.

The network 90 may enable various types of information to be communicated between the hospital server 10, the health management server 20, the grocery store server 30, the public institution server 40, the airport server 50, and the electronic device 100. The network 90 may include wired/wireless communication networks and mobile communication networks, and may also include any types of networks currently present or to be appeared in the future.

The electronic device 100 may provide various types of information to a user at an appropriate time and place, and the electronic device 100 may receive various types of information to be sent to a user from at least one of the hospital server 10, the health management server 20, the grocery store server 30, the public institution server 40, and the airport server 50. Detailed functions of the electronic device 100 will be described below.

Hereinafter, the electronic device 100 will be described in greater detail with reference to the accompanying drawings.

As used herein, the terms “module” and “unit” may be used together for a component for convenience of writing the specification and do not make any substantial difference there between.

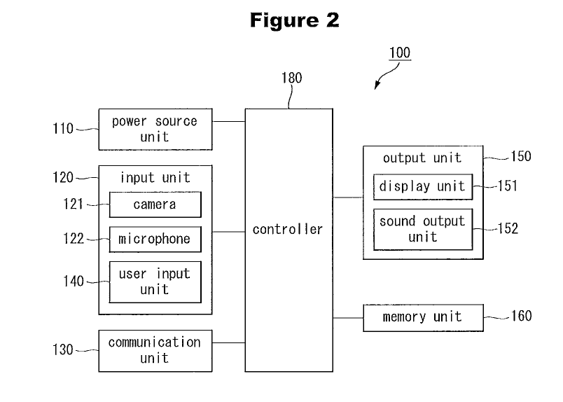

FIG. 2 illustrates a construction of the electronic device 100 according to an embodiment of the present invention.

The electronic device 100 may include a power source unit 110, an input unit 120, a communication unit 130, an output unit 150, and a memory unit 160. The afore-mentioned components are not necessary and thus more or less components may be included to implement the electronic device 100.

The power source unit 110 supplies power necessary for operation to each of the components configuring the electronic device 100.

The input unit 120 receives an audio signal, a video signal, and a user input from a user, and may include at least one of a camera 121, a microphone 122, and a user input unit 140.

The camera 121 processes an image frame, such as a still image or a moving picture which is obtained by an image sensor in a video call mode or an image capturing mode. The processed image frame may be displayed on the display unit 151.

The image frame processed by the camera 121 may be stored in the memory unit 160 or may be transmitted to an outside through the communication unit 130. Two or more cameras 121 may be included according to an aspect of the electronic device.

The microphone 122 receives an external sound signal in a call mode or recording mode, or in a voice recognition mode and processes the received sound signal as electrical voice data.

The user input unit 140 may be implemented as a key pad, a dome switch, a touchpad (resistive/capacitive types), a jog wheel, or a jog switch.

The user input unit 140 is not restricted to a specific implementation. In general, as the user input unit 140, a keypad type input unit, a wheel key type input unit, a touchpad type input unit, a touch screen type input unit or a combination of two or more thereof may be employed. In light of better space utilization, request of increased display size, and enhanced design, touch screen type input units are recently employed a lot. In this case, the user input unit 140 may be integrated with the display unit 151 to be described later.

The communication unit 130 may include one or more modules that enable communication with other electronic devices including the hospital server 10, the health management server 20, the grocery store server 30, the public institution server 40, or the airport server 50. The communication unit 130 may include communication means to be used in the future as well as communication means that is currently being used.

The output unit 150 generates a visual, auditory, or tactile output, and may include a display unit 151 and a sound output unit 152. The output unit 150 may further include a haptic module (not shown) that generates a tactile output (for example, vibrations).

The display unit 151 may display information processed in the electronic device 100.

The display unit 151 may include at least one of a liquid crystal display, a thin film transistor liquid crystal display, an organic light emitting diode display, a flexible display, and a 3D display.

Two or more display units 151 may be included according to implementations of the electronic device 100.

The sound output unit 152 outputs audio data externally received or generated in the electronic device 100. That is, the sound output unit 152 may output a sound signal associated with a function performed in the electronic device 100. The sound output unit 152 may include a speaker or a buzzer. The sound output unit 152 may also output a sound through an earphone jack. A user may connect an earphone to the earphone jack to hear an output sound.

The memory unit 160 may store a program for operation of the electronic device 100 and may temporarily or permanently store data inputted/outputted/generated (for example, audios, still images, moving pictures, etc.)

The memory unit 160 may include at least one type of storing medium of flash memory types, hard disk types, multimedia card micro types, card types of memories (for example, SD or XD memories), RAMs (Random Access Memories), SRAMs (Static Random Access Memories), ROMs (Read-Only Memories), EEPROMs (Electrically Erasable Programmable Read-Only Memories), PROMs (Programmable Read-Only Memories), magnetic memories, magnetic discs, and optical discs.

The memory unit 160 may be provided separately from the electronic device 100.

The controller 180 may control the overall operation of the electronic device 100. For example, the controller 180 associates various types of information to one another and performs control or treatment so that the associated information may be used.

The various embodiments described herein may be implemented in software, in hardware, or in a medium readable by a computer or its similar device.

In the case of implementing the embodiments in hardware, the embodiments herein may be realized using at least one of ASICs (application specific integrated circuits), DSPs (digital signal processors), DSPDs (digital signal processing devices), PLDs (programmable logic devices), FPGAs (field programmable gate arrays, processors, controllers, micro-controllers, microprocessors, and electrical units conducting certain functions.

In the case of implementing the embodiments in software, embodiments, such as procedures or functions, may be realized together with a separate software module that performs at least one function or operation. Software codes may be implemented by a software application written in a proper programming language. Also, the software codes may be stored in the memory unit 160 and may be executed by the controller 180.

The methods described herein may be implemented in software. The software may be downloaded from a separate server from the electronic device 100 to the electronic device 100 and may be installed in the electronic device 100. For example, the electronic device 100 may send a request of software necessary for implementing the present invention to any server and may download the requested software from the server, so that the electronic device 100 may provide environments realized by the embodiments of the present invention to users.

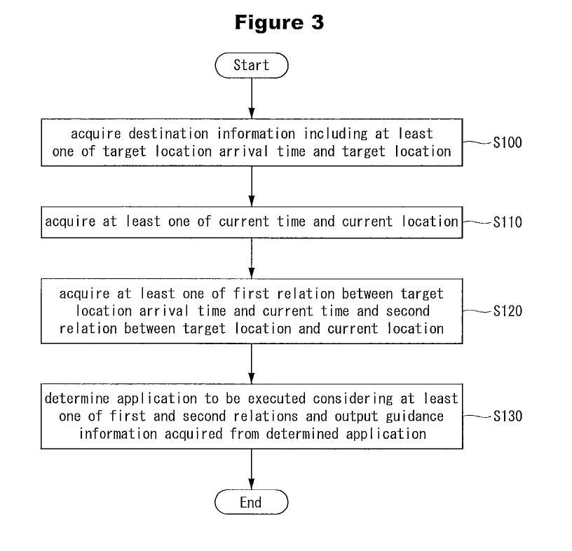

Hereinafter, a method of providing various types of information to a proper place at an appropriate time will be described with reference to FIGS. 3 to 11. However, this is for convenience of description, and the technical spirits of the present invention are not limited to a specific environment or device. The method will now be detailed with reference to FIG. 3.

FIG. 3 is a flowchart illustrating a method of providing various types of information according to an embodiment of the present invention.

As used herein, the various types of information may refer to information that may be used while a user moves to a specific place, for example, a destination. The phrase “provide various types of information” may mean that the information usable by the user while the user moves to the destination are provided based on a current time and a current place. For example, when the user moves to destination A, the electronic device 100 may provide various types of information depending on a change in time from a depart time to an arrival time, or may provide various types of information based on a change in position from a current location to a destination. At this time, the electronic device 100 may obtain various types of information to be sent to the user through a diversity of applications and may provide the obtained information to the user based on a current time and/or a current location.

The controller 180 of the electronic device 100 may obtain destination information including at least one of a destination location and a arrival time taken to arrive at the destination location (S100).

By obtaining the destination information, the controller 180 may determine an application that is executed based on at least one of a current time and a current location as will be described later. The controller 180 may output various types of information from the determined application to the user through the output unit 150.

The target location and the destination location herein may be used as synonyms, and the target location arrival time and the destination arrival time may be used as synonyms.

To obtain the destination information, the controller 180 may receive the destination information from the user or may obtain the destination information from a user's schedule.

For example, the controller 180 may receive a destination arrival time and a destination location, as desired by the user, from the user input unit 140.

More specifically, the user may input the destination location by entering an address of the destination through the user input unit 140 or by touching a desired destination on a map outputted on the output unit 150.

Similarly to this, the user may also input the destination arrival time by entering the destination arrival time through the user input unit 140.

Unlike this, the user may input the destination arrival time and the destination location through the microphone 122.

By the above methods, the user may input, for example, “15:00 PM” as the destination arrival time and “hospital A” as the destination location. By doing so, the controller 180 may obtain the destination information that the user should go to hospital A at 15:00 PM, and the controller 180 may store the obtained destination information in the memory unit 160 or an external server.

On the contrary, the controller 180 may obtain the destination information from a user's schedule. The user's schedule may refer to various applications used by the user to manage his schedules. For example, the user scheduler application may include the Outlook™ of Microsoft. The user scheduler applications may store the user's schedule in the memory unit 160 or an external server accessible by the electronic device 100 according to its functions. Accordingly, the controller 180 may obtain the user's schedule from the memory unit 160 or the external server. In this case, the controller 180 may also obtain the destination information that the user should go to hospital A at 15:00 as described earlier.

The controller 180 may obtain at least one of a current time and a current location (S110).

The controller 180 may obtain the current time by obtaining a standard time from the communication unit 130.

Also, the controller 180 may obtain information related to the current location of the electronic device 100 from the communication unit 130.

For example, the controller 180 may obtain the current location of the electronic device 100 by receiving information related to the current location, for example, a GPS (Global Positioning System) signal, through the communication unit 130 and processing the received GPS signal.

Further, the controller 180 may receive the information related to the current location from a wireless Internet access point and/or a base station that manages the electronic device 100. The controller 180 may obtain the current location of the electronic device 100 by processing the information related to the current location as received by the wireless Internet access point and/or the base station.

The above methods of obtaining the current location of the electronic device 100 by the controller 180 may be performed separately from each other or in combination thereof for enhancement in accuracy.

As such, the controller 180 may obtain at least one of the current time and the current location of the electronic device 100.

The controller 180 may obtain at least one of a first relation between the destination arrival time and the current time and a second relation between the destination location and the current location (S120).

The controller 180 may obtain at least one of the first relation between the destination arrival time and the current time and the second relation between the destination location and the current location based on the information obtained in steps S100 and S110.

The “first relation” herein may refer to information indicating whether the current time is before or after the destination arrival time, or how much time is remained until the current time reaches the destination time in the case that the current time is before the destination time. And, the “second relation” herein may refer to information indicating whether the current location is equal to the destination location, or how far the current location is from the destination location in the case that the current location is away from the destination location.

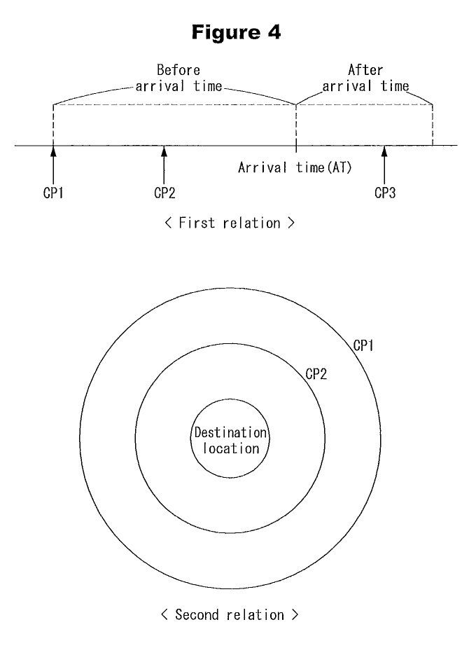

As shown in an upper part of FIG. 4, the controller 180 may determine whether the current time corresponds to CT1 and CT2 prior to the destination arrival time or corresponds to CT3 after the destination arrival time based on the destination arrival time. Also, the controller 180 may determine whether the current time corresponds to CT1 or CT2 based on the remaining time until the destination arrival time in the case that the current time is before the destination arrival time. CT1 may have more remaining time than that of CT2 until the destination arrival time.

For example, the controller 180 may obtain the first relation indicating that two hours are remained from the current time until the destination arrival time by obtaining information indicating that the destination arrival time is 15:00 PM and the current time is 13:00 PM. However, this is merely an example. The remaining time until the destination arrival time may be longer or shorter than that. Further, the current time may be past the destination time.

Accordingly, the controller 180 may determine through the first relation how much time is remained until the destination arrival time and/or whether the current time was past the destination arrival time.

Meanwhile, the controller 180 may determine whether the current location corresponds to CP1 or CP2 depending on the degree of the current location approaching the destination location as shown in a lower part of FIG. 4. Here, the electronic device 100 is farther away from the destination location in the case of CP1 than CP2.

For example, the controller 180 may obtain the second relation indicating that the current location B is away from hospital A which is the destination location by 10 km by obtaining information that the destination location is hospital A and the current location is B. This is merely an example, and thus, the distance between the current location and the destination location may be shorter or longer than that.

Accordingly, the controller 180 may determine how far the current location of the electronic device 100 is away from the destination location through the second relation.

The controller 180 may determine an application to be executed considering at least one of the first relation and the second relation and may output guidance information obtained from the determined application (S130).

The application as used herein may refer to various application programs for providing any information to the user. Also, the various applications herein may refer to a single multi-application performing various functions or a plurality of separate applications.

The controller 180 may determine guidance information to provide based on the first and second relations, may determine an application necessary for obtaining the determined guidance information, may obtain the guidance information from the determined application, and may provide the obtained guidance information to the user at a predetermined time and/or location.

More specifically, the controller 180 may determine how much time remains until the destination arrival time, may determine what guidance information the controller 180 is to provide based on the degree of the remaining time or whether the destination arrival time was past (the first relation), and may determine the application to be executed accordingly.

That is, as time goes by from the time starting toward the destination to the destination arrival time, the controller 180 may execute different applications to provide various types of guidance information. For example, the controller 180 may execute a first application at the departure time, a second application 10 minutes after the departure time, a third application 30 minutes before the destination arrival time, a fourth application 10 minutes before the destination arrival time, and a fifth application after the destination arrival time.

By doing so, as the current time approaches the destination arrival time, the user may receive necessary information at a proper time depending on whether the current time has been past the destination arrival time.

Also, the controller 180 may determine how long distance is remaining until the destination location, and may execute different applications to provide various types of information according to the remaining distance (the second relation). That is, the controller 180 may execute different applications as the position varies from the departure position starting toward the destination to the destination location. For example, the controller 180 may execute application at the departure location toward the destination, applications b and c as approaching the destination location, and application d when arriving at the destination location.

By doing so, the user may receive necessary information at a proper location according to a relative position of the current location with respect of the destination location.

Also, the controller 180 may use the first and second relations in combination thereof. For example, in a case where the current time is prior to the destination location arrival time in the first relation and the current location corresponds to the target location in the second relation, the controller 180 may execute a predetermined application and may obtain the guidance information from the executed application.

More specifically, in a case where the current time is prior to the destination location arrival time in the first relation and the current location corresponds to the target location in the second relation, the controller 180 may execute an application determined to be executed when the current location is the target location but may not execute an application determined to be executed when the current time is before the target location arrival time.

Referring to the above-described example, the controller 180 may execute application d without executing the first to fourth applications.

As another example, in a case where the current location is away from the target location in the second relation, that is, when in the first relation the current time is at or past the target location arrival time or it is determined that the electronic device 100 cannot arrive at the target location within the target location arrival time while the electronic device 100 does not arrive at the target location, the controller 180 may execute the predetermined application. For example, the controller 180 may execute an application related to reservation as the predetermined application.

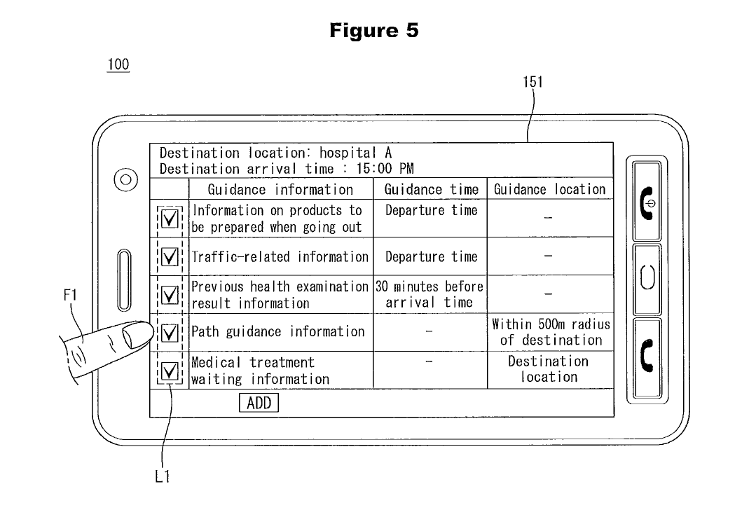

Hereinafter, an embodiment of the present invention will be described with reference to FIG. 5 where what guidance information will be provided at the current time and/or the current location, that is what application will be determined to be executed.

FIG. 5 is a view illustrating an exemplary application to be executed according to an embodiment of the present invention. FIG. 5 illustrates the first relation and/or the second relation and a matching table for an application to be executed. That is, the matching table may provide information on what application will be executed based on the remaining time until the destination arrival time according to the first relation, or information on what application will be executed based on the remaining time until the destination location according to the second relation.

Guidance information, guidance times, and guidance locations included in the matching table shown in FIG. 5 may be received from the user or from an external server. In a case where the user generates the matching table, what guidance information may be provided through what application according to the first relation and/or the second relation may be inputted through the user input unit 140. Further, in a case where the matching table is provided from the external server, the electronic device 100 may be provided with a default on what guidance information may be provided through what application according to the first relation and/or the second relation.

In describing FIG. 5, it is assumed that among the guidance information shown in FIG. 5, article information, traffic-related information, and path guidance information are received from the external server, and among the guidance information shown in FIG. 5, health-related guidance information, for example, previous health examination result information and medical treatment waiting information are entered by the user.

In describing FIG. 5, it is assumed that the destination arrival location is hospital A and the destination arrival time is 15:00 PM.

As shown in FIG. 5, the controller 180 may determine through the matching table what guidance information should be provided based on whether the current time and/or the current location correspond to the guidance time and/or the guidance location. In other words, as shown in FIG. 5, when the current time corresponds to the guidance time or the current location corresponds to the guidance location, the controller 180 executes a corresponding application to obtain corresponding guidance information and outputs the obtained guidance information at the guidance time and/or the guidance location through the output unit 150. The guidance information may refer to information provided to the user and may be obtained through an application corresponding to the guidance information.

That is, in a case where the current time corresponds to the departure time as shown in FIG. 5, the controller 180 may provide article information and traffic-related information that should be prepared as the guidance information, may provide the previous health examination result information 30 minutes before the destination arrival time, may provide the path guidance information when the current location is within a 500-meter radius of the destination, and may provide the medical treatment waiting information when the current location corresponds to the destination location.

At this time, when the current time and/or the current location correspond to the guidance time and/or the guidance location, the controller 180 executes an application corresponding to the guidance information to obtain the guidance information. That is, the controller 180 may obtain the corresponding information by executing applications corresponding to the article information, the traffic-related information, the previous health examination result information, the path guidance information, and the medical treatment waiting information at the guidance time and/or the guidance location that should be prepared.

Meanwhile, the user may select the guidance information shown in the matching table through check boxes L1.

It should be noted that various types of guidance information may be added other than the guidance information shown in FIG. 5. For example, besides the guidance information shown in FIG. 5, the user may add guidance information saying that information on weather at the destination location intends to be provided at the departure time as the guidance information. By doing so, the user may have convenience of being able to prepare for clothes and tools according to the weather at the destination location.

As described earlier, the user may add information related to a new medical treatment reservation as the guidance information in a case where the current time is past the destination arrival time and the current location is distant from the destination arrival location by more than a predetermined reference. For instance, the information related to the new medical treatment reservation may include information on when a next medical treatment reservation time is available.

Also, for example, the user may add as the guidance information a notification message letting the user move to the destination in a case where the current time approaches the destination arrival time and the current location is distant from the destination arrival location by more than a predetermined reference. Through this, the user may be reconfirmed to move to the destination.

Meanwhile, the user may change the guidance time and/or guidance location where the user receives the guidance information. For example, the user may change the time of provision of previous health examination result information among the guidance information from 30 minutes before the destination arrival time to within 500 meter radius of the destination location. In this manner, the user may arbitrarily change the time and location of provision of the guidance information.

On the other hand, the controller 180 may employ various methods to output the obtained guidance information. For example, the controller 180 may display the obtained guidance information as a background screen of the electronic device 100. Also, for example, the controller 180 may represent the obtained guidance information as a widget on the background screen. Further, for example, the controller 180 may display the obtained guidance information in the form of a pop-up.

Meanwhile, in a case where there are a plurality of guidance information having the same guidance time and/or guidance location in providing the guidance information, the controller 180 may sequentially or simultaneously display the guidance information according to a predetermined order or user's setup. Also, in the case of displaying the guidance information at the same time, the controller 180 may divide the display unit 151 into a plurality of logical areas so that the divided areas may display different guidance information. For example, in a case where the guidance time is the departure time as shown in FIG. 5 and information on articles to be prepared and traffic-related information all should be outputted, the controller 180 may sequentially or simultaneously output the information as described above.

Meanwhile, the controller 180 may receive a setup as to until when the guidance information is displayed in various manners. For example, the guidance information may be displayed during a predetermined time, until a user's input is received, until a predetermined time, or until a predetermined location arrives. More specifically, the controller 180 may display the traffic-related information shown in FIG. 5 until a user's confirmation is inputted. Also, the controller 180 may display the path guidance information until the current location corresponds to the destination location.

Among the guidance information shown in FIG. 5, the information on articles to be prepared will now be described in detail.

As shown in FIG. 5, the information on articles to be prepared may be provided to the user in a case where the obtained current time corresponds to the departure time toward the destination. Also, the information on articles to be prepared may be obtained from an application corresponding thereto.

For example, in a case where the current time corresponds to the departure time, the controller 180 may execute an application on article information that identifies what article the user should be ready for.

More specifically, in a case where in the first relation, the current time is prior to the destination arrival time and in the second relation, the current location is different from the destination location, the controller 180 may execute the application to obtain information on an article to be prepared by the user. On the contrary, in a case where the current time corresponds to the departure time and the current location corresponds to the destination location, the controller 180 may not execute the application for obtaining the information on the article to be prepared. It is assumed hereinafter that the current location is different from the destination location and the current time is prior to the target location arrival time.

Here, the departure time may be obtained based on a time required for arriving at the destination location within the destination arrival time. In other words, the controller 180 may obtain the departure time from a user's input or may determine the departure time based on the current location, the destination location, and the destination arrival time.

For example, the controller 180 may obtain the departure time from the user toward the destination location through the user input unit 140.

Also, for example, in a case where the destination arrival time is 15:00 PM and the distance to the destination is 10 km, the controller 180 may determine that it takes 1 hour to arrive at the destination location. At this time, the controller 180 may determine the time required for more accurately arriving from the current location to the destination location by obtaining information on traffic congestion from the current location to the destination location through the communication unit 130. The controller 180 may determine the departure time based on the obtained required time and the destination arrival time. That is, because the required time is 1 hour and the destination arrival time is 15:00 PM, the controller 180 may determine that the departure time is 14:00 PM.

In a case where the obtained current time corresponds to the departure time, the controller 180 may execute an article information application that may identify what articles the user should prepare for. Here, the article information application is for purpose of notifying what articles the user should get ready for when he goes out. The article information application may notify a article related to health management according to a user's health condition. For example, in a case where the user has a high blood sugar level, the article information application may include a blood sugar medicine as an example of the article information.

For this purpose, the controller 180 may obtain information on the health-related article that should be prepared when the user is out from the user's medicine-taking schedule and/or health management server 20.

Besides, the article information that should be prepared when the user is out may include various types of information on, for example, identification or medical insurance card.

Accordingly, the user may get ready for, without missing, articles that should be prepared before he goes out because the electronic device 100 provides the information on articles needs to be prepared at the departure time toward the destination.

Among the guidance information shown in FIG. 5, traffic-related information will now be described. As shown in FIG. 5, the traffic-related information, in a case where the obtained current time corresponds to the departure time toward the destination, may be provided to the user. Also, the traffic-related information may be obtained from an application corresponding thereto.

For example, in a case where the current time corresponds to the departure time, the controller 180 may execute an application on the traffic-related information.

More specifically, in a case where in the first relation, the current time is prior to the destination arrival time and in the second relation, the current location is different from the destination location, then the controller 180 may execute the application to obtain information on the article that should be prepared by the user. On the contrary, in a case where the current time is before the destination arrival time and the current location corresponds to the destination location, the controller 180 may not execute the application on the traffic-related information. It is assumed hereinafter that the current time is prior to the destination arrival time and the current location is different from the destination location.

Description on the departure time is identical to that described above, and thus, is not repeated.

Among the guidance information, the traffic-related information may refer to information guiding traffic from the current location to the destination location.

For example, in a case where the user uses a public transportation, the traffic-related information may include at least one of information on public transportations from the current location to the destination location, expected required time, or information on transfer.

Also, for example, in a case where the user uses his vehicle, the traffic-related information may include at least one of information on path from the current location to the destination location, or expected required time.

Ahead of this, the controller 180 may provide an interface inquiring the user if the user uses a public transportation or his own car, and may be inputted with any one of them from the user through the user input unit 140.

Accordingly, by receiving the traffic-related information at the departure time toward the destination from the electronic device 100, the user may make use of traffic information to the destination location even without the need of making an effort to separately seek the traffic-related information.

Among the guidance information shown in FIG. 5, the previous health examination result information will now be described.

When the current time corresponds to 30 minutes before the destination arrival time, the previous health examination result information may be provided to the user. Also, the previous health examination result information may be obtained from an application corresponding thereto.

As described earlier, because the previous health examination result information is guidance information directly entered by the user through the user input unit 140, the guidance time may also be information directly entered by the user.

In a case where the current time corresponds to 30 minutes before the destination arrival time according to the first relation, the controller 180 may output the previous health examination result information through the output unit 150.

The previous health examination result information refers to a result of health-related medical treatment and/or health examination that was previously taken by the user.

In a case where the current time is 30 minutes before the destination, the controller 180 may obtain the user's previous health examination result information from at least one of the hospital server 10 and the health management server 20 through the communication unit 130.

The controller 180 may output the obtained previous health examination result information through the output unit 150.

Accordingly, the user may consider any inquiries that he will make to a doctor in the medical treatment that day in advance by identifying the previous health examination results.

Among the guidance information shown in FIG. 5, description will now be focused on the path guidance information. The path guidance information, as shown in FIG. 5, may be provided to the user within a 500 m radius of the destination. Also, the path guidance information may be obtained from an application corresponding thereto.

For example, in a case where the current location is located within a radius of 500 m from the destination according to the second relation, the controller 180 may output the path guidance information through the output unit 150.

More specifically, in a case where according to the first relation, the current time is prior to the destination arrival time and the user uses a public transportation, the controller 180 may provide the path guidance information to the user.

The path guidance information may include map data necessary for move from the current location to the destination location.

In a case where the current location is within a 500 m radius of the destination, the controller 180 may obtain information related to path from the current location to the destination location from the memory unit 160 or the external server and may output the path guidance information through the output unit 150 based on the obtained path-related information.

Although it has been described that the path guidance information is provided when the current location is within a 500 m radius of the destination, the path guidance information, on the contrary, may also be provided when the user gets off the public transportation.

Among the guidance information shown in FIG. 5, the medical treatment waiting information will now be described. As shown in FIG. 5, the medical treatment waiting information may be provided to the user when the obtained current location corresponds to the destination location. Also, the medical treatment waiting information may be obtained from an application corresponding thereto.

For example, in a case where the current location corresponds to the destination location, the controller 180 may execute the medical treatment waiting information. Here, the medical treatment waiting information may include at least one of expected time during which the user should wait for a medical treatment and waiting order.

In a case where the current location corresponds to the destination location, the controller 180 may access the hospital server 10 through the communication unit 130. For example, an address of the hospital server 10 may be transmitted to peripheral devices in a broadcasting manner. The controller 180 may obtain the address of the hospital server 10, and may get an access to the hospital server 10 through the address. The controller 180 may access the hospital server 10 and may obtain the medical treatment waiting information from the hospital server 10. The controller 180 may output the obtained medical treatment waiting information through the output unit 150.

Accordingly, the user may automatically receive the waiting time and order for the medical treatment without a separate input.

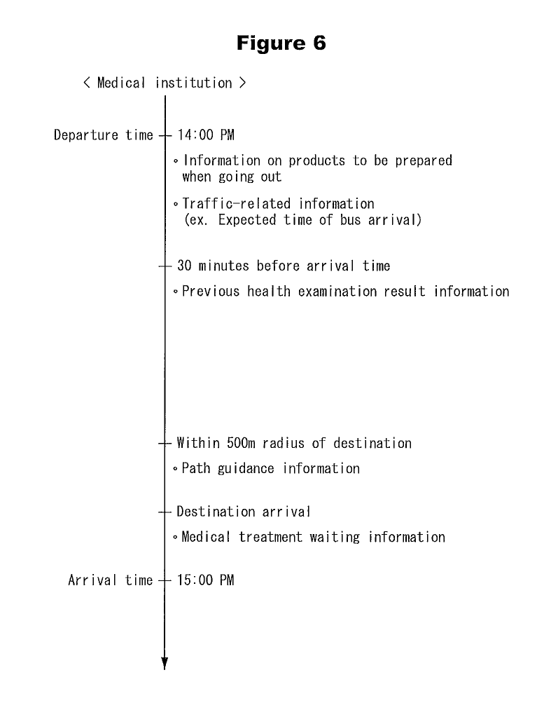

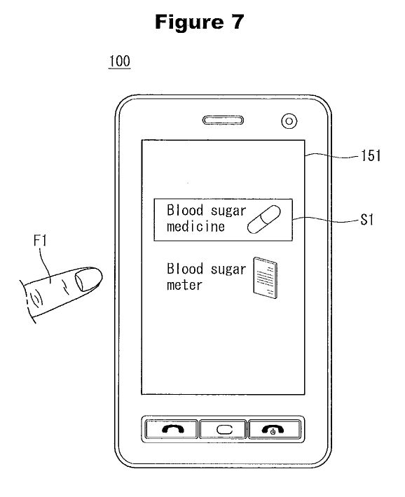

An embodiment of the present invention will now be described in greater detail. FIG. 6 illustrates an example of guidance information according to an embodiment of the present invention. Similar to the above-described embodiments, it is assumed here that as the destination information, the destination location is hospital A and the destination arrival time is 15:00 PM, and the same guidance information as that described in connection with FIG. 5 is provided. FIGS. 7 to 11 are also referred to in describing the embodiment of the present invention taken in conjunction with FIG. 6. FIGS. 7 to 11 illustrate examples of guidance information according to an embodiment of the present invention. In describing the embodiments, what have been already described above will not be repeated.

As shown in FIG. 6, in a case where according to a relation with the destination arrival time, the current time corresponds to the departure time, the controller 180 may output information on an article that should be prepared when the user goes out (hereinafter, also referred to as “must-be-prepared article information”) and the traffic-related information. For example, the controller 180 may determine the departure time as 14:00 PM based on the destination arrival time, i.e., 15:00 PM.

By executing an application for obtaining the must-be-prepared article information at 14:00 PM, the controller 180 may obtain the article information and may output the obtained must-be-prepared article information through the output unit 150.

Referring to FIG. 7, the electronic device 100 may output a blood sugar medicine and a blood sugar meter as the must-be-prepared article information. Also, by selecting the articles that he must prepare, the user may check the articles that he prepared. For example, the user may check that the blood sugar medicine was prepared by selecting the blood sugar medicine (S1). By doing so, the user may perform preparation without omission.

Although not shown, the article information may further include a health insurance card.

Also, by executing an application for obtaining the traffic-related information at 14:00 PM, the controller 180 may obtain the traffic-related information and may output the obtained traffic-related information through the output unit 150.

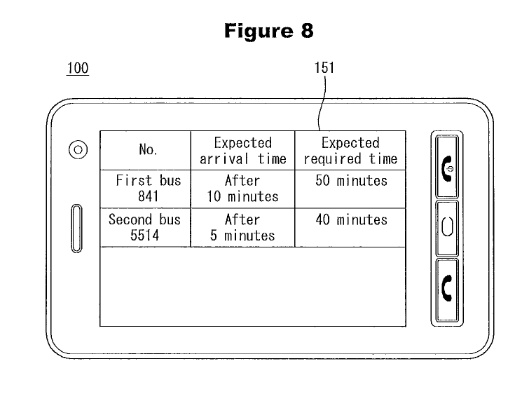

Referring to FIG. 8, the electronic device 100 may provide information on first and second buses to be used from the current location to the destination location, i.e., hospital A as the traffic-related information. Here, the traffic-related information is assumed to be public transportation information. As shown in FIG. 8, the traffic-related information may include at least one of bus number, expected bust arrival time, and expected required time. As such, the user may obtain information on what public transportation he should select, when it comes, and what the expected required time is.

By executing the application for obtaining the previous health examination result information at 14:00 PM which is 30 minutes before the arrival time, the controller 180 may obtain the previous health examination result information and may output the obtained previous health examination result information through the output unit 150.

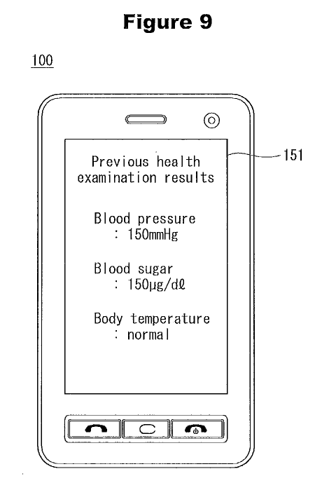

Referring to FIG. 9, the electronic device 100 may provide information that includes at least one of blood pressure, blood sugar, and body temperature as previous health examination results. These are merely an example of the previous health examination results, and more various previous health examination results may be included.

Also, by executing the application for obtaining the path guidance information when being located within a 500 m radius from the destination, the controller 180 may obtain the path guidance information and may output the obtained path guidance information through the output unit 150.

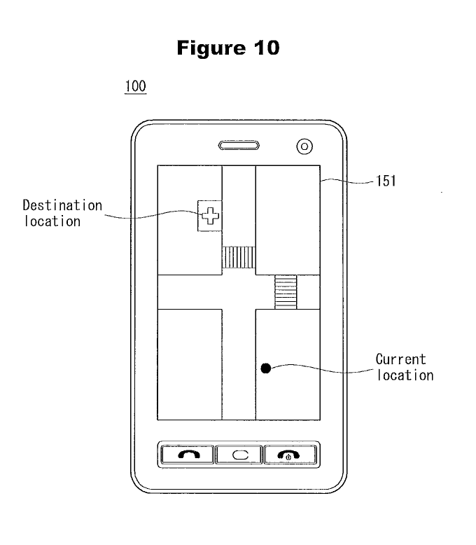

Referring to FIG. 10, the electronic device 100 may provide path guidance from the current location to the hospital A that is the destination location as the path guidance information.

Also, in a case where the current location corresponds to the destination location, i.e., hospital A, the controller 180 may execute an application for obtaining the medical treatment waiting information to obtain the medical treatment waiting information and may output the obtained medical treatment waiting information through the output unit 150.

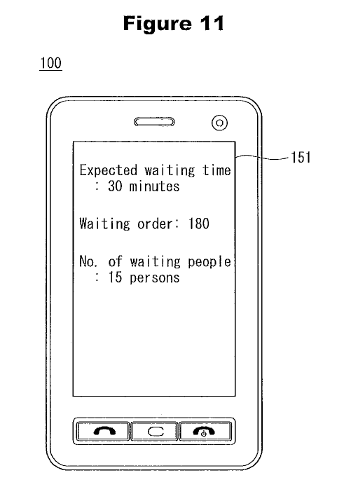

Referring to FIG. 11, the electronic device 100 may provide information, such as expected waiting time, waiting order, number of waiting people, as the medical treatment waiting information.

According to the specific embodiment described above, the electronic device 100 may provide various types of information to the user based on hospital A (destination location) and 15:00 PM (destination arrival time). As described earlier, the electronic device 100 may provide the user with the information on the articles that should be prepared and the traffic-related information at the departure time, may provide the user with the previous health examination result information 30 minutes before the destination arrival time, may provide the user with the path guidance information within a 500 m radius of the destination, and may provide the user with the medical treatment waiting information at the destination location. That is, the user may be provided various types of information from the electronic device 100 based on the current time and current location.

On the other hand, the electronic device 100 may provide different types of guidance information depending on properties of the destination. Hereinafter, a method of providing guidance information depending on the properties of the destination will be described.

The phrase “properties of destination” herein refers to types of destination. For example, the types of destination may be diverse, such as medical institutions, grocery stores, public institutions, airports, etc. At this time, the electronic device 100 may provide guidance information necessary for the user depending on the properties of the destination.

For example, in a case where the type of destination is a medical institution, the electronic device 100 may provide guidance information that may be used particularly in the medical institution, in a case where the type of destination is a grocery store, the electronic device 100 may provide guidance information that may be used particularly in the grocery store, in a case where the type of destination is a public institution, the electronic device 100 may provide information particularly related to the public institution as guidance information, and in a case where the type of destination is an airport, the electronic device 100 may provide information related to the airport as guidance information.

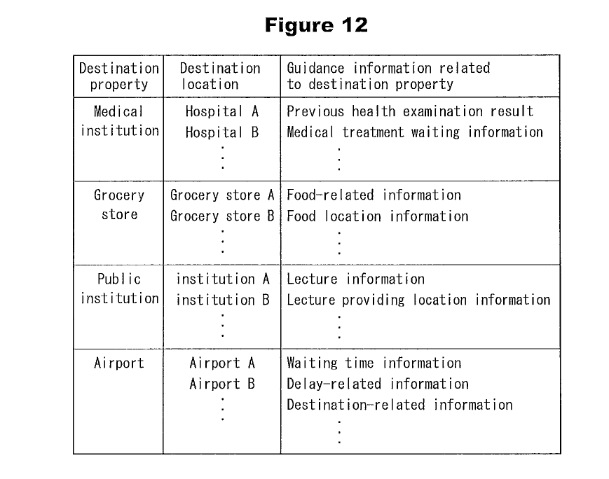

More specifically, the electronic device 100 may determine the type of destination based on the destination location. For example, referring to FIG. 12, in a case where the destination location is hospital A or B, the electronic device 100 may determine that the type of destination is a medical institution, in a case where the destination location is grocery store A or B, the electronic device 100 may determine that the type of destination is a public institution, and in a case where the destination location is airport A or B, the electronic device 100 may determine that the type of destination is an airport. As such, the electronic device 100 may determine what destination property corresponds to the destination location.

Also, the electronic device 100 may determine what guidance information is provided according to the determined destination property. The information on what guidance information is provided according to the determined destination property may be stored in the memory unit 160 of the electronic device 100 or an external server. That is, the electronic device 100 may obtain what guidance information is provided according to the determined destination property from the memory unit 160 or the external server.

More specifically, as shown in FIG. 12, in a case where the destination property is a medical institution, the electronic device 100 may provide health-related guidance information, such as, for example, the previous health examination result guidance information or medical treatment waiting guidance information, as the guidance information matching the destination property.

In fact that the electronic device 100 provides the previous health examination result guidance information and the medical treatment waiting guidance information, this embodiment may be identical to the embodiment described in connection with FIG. 5. However, in the embodiment described in connection with FIG. 5, the user directly enters the previous health examination result guidance information and the medical treatment waiting guidance information through the user input unit 140. However, in the embodiment described in connection with FIG. 12, in a case where the electronic device 100 has a destination property of a medical institution, the previous health examination result guidance information and the medical treatment waiting guidance information are provided even without user's entry. In other words, unlike in the embodiment described in connection with FIG. 5, in the embodiment described in connection with FIG. 12, the electronic device 100 may recommend guidance information matching the destination property to the user considering the destination property.

Also, in a case where the destination property is a grocery store, the electronic device 100 may provide as guidance information matching the destination property food-related guidance information according to health conditions and food location guidance information, in a case where the destination property is a public institution, the electronic device 100 may provide as guidance information matching the destination property lecture guidance information provided by the public institution and location guidance information of a lecture room providing a lecture, and in a case where the destination property is an airport, the electronic device 100 may provide as guidance information matching the destination property airplane waiting time guidance information, delay-related guidance information, and path guidance information.

Also, the electronic device 100 may consider the destination property in the case of providing the same guidance information. For example, the electronic device 100 may consider the destination property in the case of providing information on articles that should be prepared as described above. More specifically, in a case where the destination is a medical institution, the article information may include a health insurance card that is an article used in the destination as described above. Also, for example, in a case where the destination is a public institution, the article information may include an identification card, and in a case where the destination is an airport, the article information may include a passport, a visa, or a flight ticket.

In a case where the current time and/or the current location correspond to a predetermined guidance time and/or guidance location, the electronic device 100 may output the guidance information matching the destination property through the output unit 150.

The electronic device 100 may provide guidance information related to the destination property to the user at the predetermined guidance time and/or guidance location, and may receive the guidance time and/or the guidance location from the user. For this purpose, the electronic device 100 may provide a user interface to the user to obtain the guidance time and/or guidance location of providing the user with the guidance information related to the destination property.

Accordingly, in a case where the obtained current time and/or the current location correspond to the guidance time and/or the guidance location as described above, the electronic device 100 may execute a corresponding application to obtain the guidance information corresponding to the destination property and may output the guidance information matching the destination property obtained from the executed application through the output unit 150.

Even in the case of executing the application to provide the guidance information customized according to the type of destination in accordance with an embodiment of the present invention, it is apparent that the controller 180 may determine whether to execute the application depending on the first relation and/or the second relation as described above.

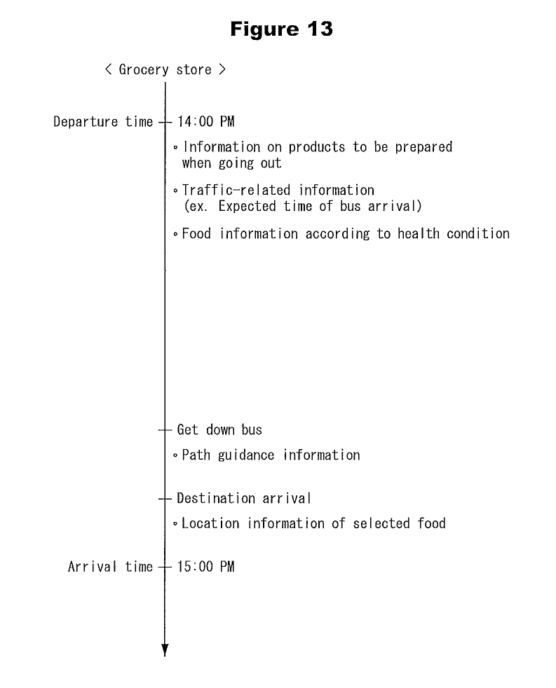

It will now be described with reference to FIGS. 13 to 18 that the electronic device 100 provides guidance information corresponding to the type of destination according to the type of destination.

FIG. 13 illustrates an example of guidance information in a case where the destination is a grocery store according to an embodiment of the present invention.

In a case where the destination arrival time is 15:00 PM, the destination location is grocery store A, and the destination property is the grocery store, the electronic device 100 may output at least one of information on articles that should be prepared when the user goes out, traffic-related information, information on food recommended according to health condition as health-related guidance information, path guidance information, and location information of selected food as described in FIG. 13. Description on the information on articles that should be prepared when the user goes out and the traffic-related information as described in connection with FIG. 6 will be omitted.

The controller 180 of the electronic device 100 may output the food-related information according to health condition at 14:00 PM which is the departure time through the output unit 150. Here, the guidance time of the food information according to health condition is assumed to be the departure time.

The food information according to health condition may include information on food helpful for user's health condition and food harmful for user's health condition.

In a case where the current time corresponds to 14:00 PM that is the departure time, the controller 180 may execute an application for obtaining the food information according to health condition. The controller 180 may obtain the food information according to health condition through the application. More specifically, the controller 180 may obtain the food information according to health condition by accessing at least one of the hospital server 10 and the health management server 20. The food information according to health condition may include information helpful for disease or food harmful for disease based on disease information owned by the user. The controller 180 may output the obtained food information according to health condition through the output unit 150.

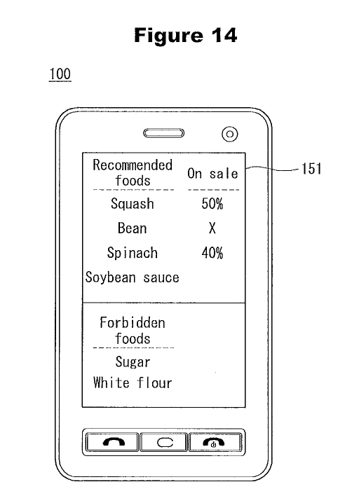

As described in FIG. 14, the controller 180 may output the obtained food information according to health condition through the output unit 150 at 14:00 PM which is the guidance time.

As shown in FIG. 14, the controller 180 may also output information on foods on sale in grocery store A among recommendation foods through the output unit 150. For this purpose, the controller 180 may access the grocery store server 30 to obtain information on what food is on sale among the recommendation foods and what the discount rate is around.

By doing so, the user may obtain information on what foods are good for his health or what foods are harmful for his health and thus may focus more on health management.

Also, the user may create a bookmark for a certain food by selecting food he intends to buy among the recommendation foods.

On the other hand, in a case where the current location corresponds to a bus stop location, the controller 180 may provide path guidance information up to the grocery store A. By doing so, the user may receive path guidance to move to the grocery store A after he gets off the bus.

Meanwhile, in a case where the current location corresponds to the destination location, the controller 180 may output the location information of the selected food through the output unit 150. The location information of the selected food may be information indicating where the food bookmarked by the user for purchase is located in grocery store A. For example, the location information of the selected food may be a map for an inside of grocery store A.

For this purpose, in a case where the current location corresponds to the destination location, the controller 180 may obtain the map of the inside of grocery store A and may output the map together the location on the map where the food bookmarked by the user is located through the output unit 150.

Here, the food bookmarked by the user may be at least one of food selected among the above-described food information according to health condition and food that the user separately marked for purchase.

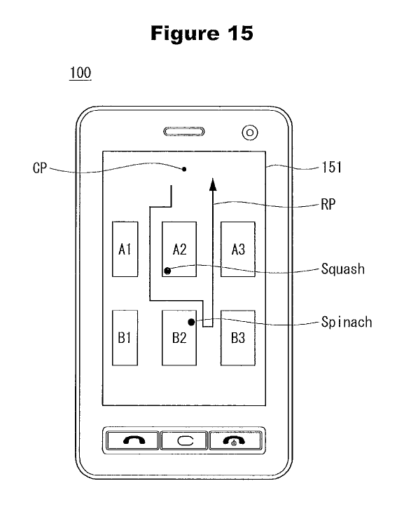

As shown in FIG. 15, while outputting the location information of the selected food through the output unit 150, the controller 180 may output the current location and location of the selected food and a recommendation path RP along with the map of grocery store A. Accordingly, the user may intuitively identify where the food he desires to buy is located in the store and may identify where he should move to conveniently purchase the food through the recommendation path RP.

It has been described that the destination property is a grocery store. It will now be described that the type of destination is a public institution. Similar to the foregoing description, it is assumed that the destination arrival time is 15:00 PM.

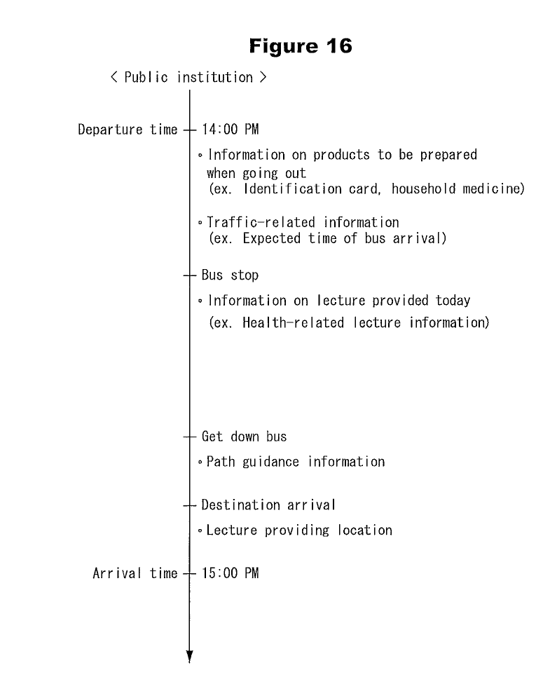

FIG. 16 illustrates an example of guidance information in a case where the destination is a public institution according to an embodiment of the present invention.

In a case where the destination arrival time is 15:00 PM, the destination location is public institution A, and the destination property corresponds to a public institution, the controller 180 of the electronic device 100 may output at least one of information on articles that should be prepared when the user goes out, traffic-related information, information on lecture provided today as health-related guidance information, path guidance information, and lecture providing location information as shown in FIG. 16. Description on the same guidance information as that described above will not be repeated.

In a case where the current location corresponds to a bus stop located on the way to the destination, the controller 180 of the electronic device 100 may execute an application for obtaining the information on lecture provided today. The controller 180 may access the public institution server 40 through the application to obtain the information on lecture provided by public institution A and may output the obtained information on lecture provided today through the output unit 150.

Also, the controller 180 may continue to provide the information on lecture provided today until the user gets off the bus. By doing so, the user may be provided with something related to the destination and useful to watch while on the move by bus.

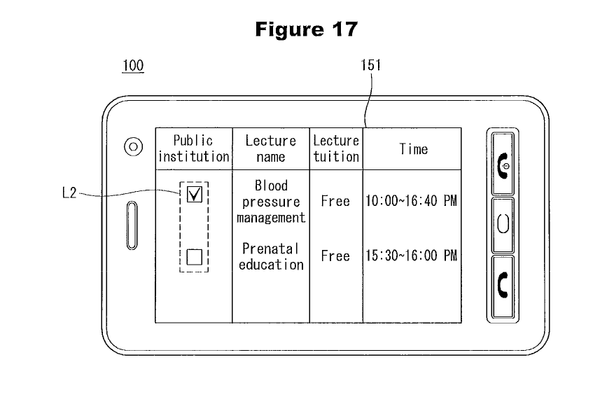

As shown in FIG. 17, the information on lecture provided today may include information related to lecture provided by public institution A. As described in FIG. 17, the controller 180 may provide information on at least one of lecture name, lecture fee, time, and instructor as information on lecture provided after the destination arrival time.

Also, the electronic device 100 may receive selection of a certain lecture from the user. For example, the user may make a reservation to a certain lecture by selecting a lecture he desires to listen to through check boxes L2 shown in FIG. 17.

On the other hand, in a case where the current location corresponds to public institution A, the controller 180 may output information on a location providing the selected lecture through the output unit 150. For this purpose, the controller 180 may obtain information on a lecture room for the selected lecture through a corresponding application and may output the information through the output unit 150.

Also, in a case where the selected lecture time comes up, the controller 180 may provide an alarm to the user before a predetermined time to refresh user's attention.

It has been described that the destination property is a public institution. It will now be described that the type of destination is an airport. It is assumed likewise that the destination arrival time is 15:00 PM.

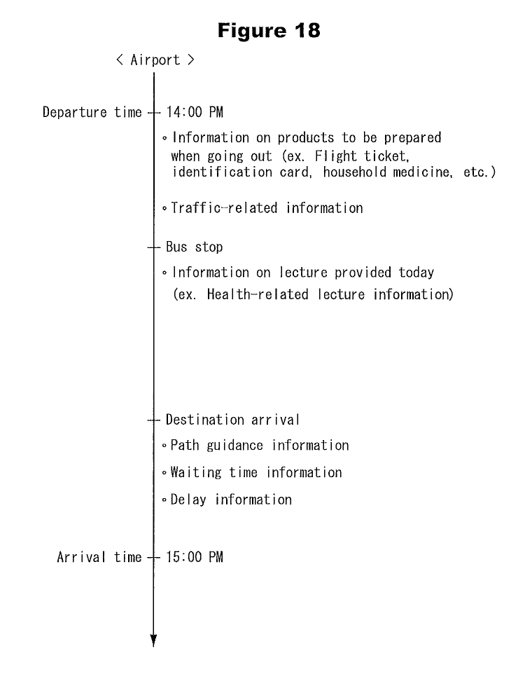

FIG. 18 illustrates an example of guidance information in a case where the destination is an airport according to an embodiment of the present invention.

In a case where the destination arrival time is 15:00 PM, the destination location is airport A, and the destination property is an airport, the controller 180 of the electronic device 100 may output at least one of information on articles that should be prepared when the user goes out, traffic-related information, path guidance information, waiting time information, and delay time information as shown in FIG. 18. Description on the same guidance information as that described above will not be repeated.

The controller 180 may provide path guidance information to a flight boarding gate in a case where the current location is airport A that is the destination. For example, by accessing the airport server 50 through a corresponding application, the controller 180 may obtain information on a path reaching a gate on which the user is to board and may output the path guidance information through the output unit 150 based on the obtained path information.

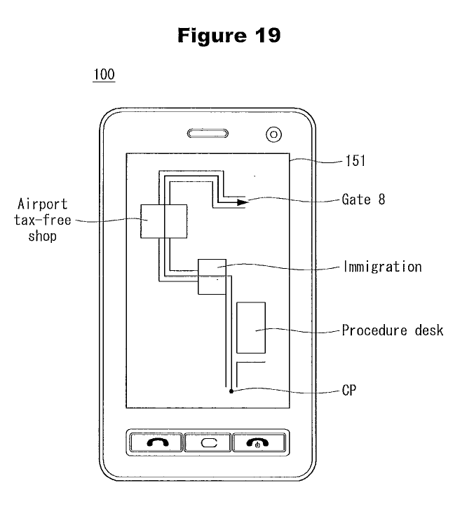

As shown in FIG. 19, the controller 180 may output through the output unit 150, information on a user's current location CP, a procedure desk, an immigration checkpoint, an airport duty-free shop, and a boarding gate. The controller 180 may continue to output the path guidance information through the output unit 150 until the user's current location moves to the gate location. Also, in a case where the user is off the path, the controller 180 may output through the output unit 150 a voice message or alarm notifying the user that the user is off the path. Accordingly, the user may be clearly guided to where he will head for in a broad space, such as an airport.

Also, in a case where the destination property is an airport, the controller 180 may output at least one of waiting time information and delay information to the user through the output unit 150.

For example, the waiting time information may be information on an average time when the user should wait for a boarding procedure. Also, the delay information may be, for example, information related to a delay of flight reserved by the user.

For example, in a case where the current location corresponds to the destination location, that is, the current location is airport A, the controller 180 may execute a corresponding application to obtain at least one of the waiting time information and the delay information and may output the at least one of the waiting time information and the delay information as obtained through the output unit 150.

By doing so, the user may be automatically provided with information on how much time he should wait in the airport and whether the flight will be delayed even without a separate search.

Although not shown, in a case where the current location corresponds to airport A that is the destination, the controller 180 may output information on where the user is headed for by flight through the output unit 150. For example, the controller 180 may obtain information on the place where the user's flight is oriented by executing a corresponding application and may output the obtained information through the output unit 150. For example, the information on the place where the user's flight is oriented may include various types of information, such as weather information or incident information.

Accordingly, the user may be provided with local information even without a separate search.

The various embodiments disclosed herein may be may be implemented alone or in combination thereof. Steps including each embodiment may be combined with steps including the embodiments for implementation.

Although the medical institution, grocery store, public institution, and airport have been exemplified in the above embodiments, the technical spirits of the present invention are not limited thereto and other types of destination may also be applied.

The method according to the present invention as described above may be recorded in a recording medium readable by computers. The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

The method according to the present invention may be executed through software. The software may include code segments that perform required tasks. Programs or code segments may also be stored in a processor readable medium or may be transmitted according to a computer data signal combined with a carrier through a transmission medium or communication network.

According to the present invention, there may be provided an electronic device and an operation method of the electronic device that, as the current time and/or current location vary, may obtain guidance information through an application corresponding to the varied time and/or varied location and may provide the obtained guidance information to the user to thereby provide the user with necessary information at the proper time and proper location.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. An electronic device comprising:
an output unit; and
a controller configured to execute one or more applications, wherein
the controller obtains at least one of a destination location and a destination location arrival time, determines an application to be executed considering at least one of a first relation between a current time and the destination location arrival time and a second relation between a current location and the destination location, obtains guidance information related to health from the determined application, and outputs the obtained health-related guidance information through the output unit, wherein as one of the first relation and the second relation changes, the determined application varies.

2. The electronic device of claim 1, wherein the controller outputs the obtained health-related guidance information through an idle screen or a widget via the output unit.

3. The electronic device of claim 1, wherein the controller obtains at least one of the destination location and the destination location arrival time from a schedule.

4. The electronic device of claim 1, wherein in a case where the current time is prior to the destination location arrival time in the first relation, the controller executes a predetermined application.

5. The electronic device of claim 4, wherein in a case where the current location corresponds to the destination location in the second relation, the controller executes a predetermined application based on the second relation.

6. The electronic device of claim 1, wherein the controller determines an application to be executed depending on a type of destination of the destination location.

7. The electronic device of claim 6, wherein in a case where the type of destination is a medical institution, the health-related guidance information includes at least one of previous health examination record information and medical treatment waiting-related information.

8. The electronic device of claim 6, wherein in a case where the type of destination is a grocery store, the health-related guidance information includes information related to a recommendation food based on a health condition.

9. The electronic device of claim 8, wherein in a case where the current location corresponds to the destination location in the second relation, information related to a location of food selected based on the recommendation food-related information is outputted.

10. The electronic device of claim 6, wherein in a case where the type of destination is a public institution, the health-related guidance information is health-related lecture information.

11. An operation method of an electronic device comprising the steps of:
obtaining at least one of a destination location and a destination location arrival time;
determining an application to be executed considering at least one of a first relation between a current time and the destination location arrival time and a second relation between a current location and the destination location;
obtaining guidance information related to health from the determined application; and
outputting the obtained health-related guidance information through an output unit, wherein as one of the first relation and the second relation changes, the determined application varies.

12. The method of claim 11, wherein the controller outputs the obtained health-related guidance information through an idle screen or a widget of the output unit.

13. The method of claim 11, wherein an application to be executed is determined depending on a type of destination of the destination location.

14. The method of claim 13, wherein in a case where the type of destination is a medical institution, the health-related guidance information includes at least one of previous health examination record information and medical treatment waiting-related information.

15. A computer-readable medium recording a program for executing the method of claim 11.
